(19) United States
(12) Patent Application Publication
(10) Pub. No.: US 2013/0249468 A1
(43) Pub. Date: Sep. 26, 2013

(54) BATTERY MANAGEMENT SYSTEM FOR RESTRICTED IDLE VEHICLES

(71) Applicants: Pranay Kumar Bajjuri, Allen, TX (US); John Jacob, Fort Wayne, IN (US)

(72) Inventors: Pranay Kumar Bajjuri, Allen, TX (US); John Jacob, Fort Wayne, IN (US)

(73) Assignee: International Truck Intellectual Property Company, LLC, Lisle, IL (US)

(21) Appl. No.: 13/990,467

(22) PCT Filed: Dec. 3, 2010
(86) PCT No.: PCT/US10/58893

§ 371 Date: May 30, 2013

(51) Int. Cl. B60L 11/18; H02J 7/00

(52) U.S. Cl. CPC B60L 11/1809; H02J 7/0054
USPC 320/104; 320/109

(57) ABSTRACT

A vehicle electrical power system includes a generator which generates power for application to loads and to chassis and batteries for storage. A starter motor for an engine is energized primarily from the battery. A contactor between the batteries has a closed state in which power can flow between the batteries and an open state which interrupts power flow between the batteries and from the generator to the cranking battery. A controller enables periodic stopping and starting of the engine is responsive to a battery state of charge for at least one of the batteries for operating the engine to maintain a minimum battery state of charge. The contactor may have a limited closed state in which power flow between the batteries is surge limited. Power flow is surge limited through the connector responsive to a voltage difference between the batteries.

### BACKGROUND

1. Technical Field

The technical field relates to vehicle electrical power storage systems and related control systems.

2. Description of the Problem

Electrical systems for motor vehicles equipped with internal combustion engines include loads, alternators for generating electricity, a rechargeable storage battery system, distribution wiring for transmitting electrical power from the alternator to the storage batteries and loads, and an electrical starter motor drawing power from the storage battery system for cranking the internal combustion engine. A control system can be used to provide control over the loads, storage batteries, starter motor and operation of the internal combustion engine. Control functionality may be implemented using a variety of switches, contactors, direct current (DC) to alternating current (AC) inverters, DC/DC converters, connectors of various sorts such as latching relays and switches which interconnect the storage batteries and loads, and electric control elements such a microcontrollers and controller area networks (CAN).

In U.S. Pat. No. 7,336,002 (Kato, et al.) it was pointed out a vehicle storage battery system may be split between applications and include batteries of more than one type. On some vehicles the storage battery system is split into two groups one of which carries most vehicle loads and the second of which is reserved for supplying power to the starter motor. In such a system the two sections of the storage battery system are sometimes called the main/primary and auxiliary batteries, or, more intuitively, the chassis (supporting a variety of system loads) and cranking batteries. Among the reasons for providing distinct chassis and cranking batteries is to isolate electrical loads from the substantial voltage variations resulting from starter motor operation. In addition, having two groups of batteries provides some system redundancy and serves to isolate the cranking battery from power drains on the chassis battery during auxiliary operation of vehicle electrical loads. This provides greater assurance of being able to start the vehicle's engine after a period of sustained electrical power demand by limiting the power drain to the chassis battery.

The batteries of different groups may be of distinct types. One possible arrangement is to use lead acid batteries for the chassis battery and the lithium-ion batteries for the cranking battery. It is possible to select lead acid and lithium ion batteries which exhibit closely matched charge profile acceptance capabilities which simplifies control over recharging. However, lithium-ion batteries are more generally susceptible to damage during recharging due to environmental conditions, particularly low temperatures.

Off duty electrical power demands on vehicles such as commercial trucks have tended to increase in recent years. Vehicle crew cabins may be equipped with appliances and lighting for the comfort of the off duty driver. Auxiliary operation of these devices require electrical power. In the past drivers routinely allowed vehicle engines to idle to support generation of the needed electrical power, however sustained idling was inefficient, noisy, contributed to pollution and is now largely unlawful. As a consequence extended vehicle idling is legally circumscribed and vehicles are periodically started and stopped to generate and store electricity to meet power demands when the vehicle is not in motion. Meeting these operational demands stresses batteries more than was the case when the vehicle could simply left running and can force battery recharging to occur under less than ideal conditions.

### SUMMARY

A motor vehicle electrical power supply system operates from an internal combustion engine which produces mechanical power which is coupled to a generator which generates electrical power for application to loads and to chassis and cranking batteries for storage. A starter motor for the internal combustion engine is energized primarily from the cranking battery. A multi-state contactor between the chassis battery and the cranking battery is provided which has a closed state in which electrical power can flow between the chassis battery and the cranking battery and an open state which interrupts electrical power flow between the cranking battery and the chassis battery and from the generator to the cranking battery. An idling switch is provided having active and inactive states. A controller responsive to the state of the idling switch for enabling operation of the internal combustion engine is responsive to a battery state of charge for at least one of the cranking battery and the chassis battery for periodically starting and stopping of the internal combustion engine to maintain a minimum battery state of charge. The multi-state contactor may have an additional limited closed state in which electrical power flow between the chassis battery and the cranking battery is surge limited. Power flow is surge limited through the multi-state connector responsive to a minimum voltage difference between the chassis battery and the cranking battery.

### BRIEF DESCRIPTION OF THE DRAWINGS

FIG. 1 is a high level schematic of a vehicle electrical power generation, storage and distribution system.

FIG. 2 is a schematic diagram of a vehicle electrical power generation, storage and distribution system.

FIG. 3 is a flow chart relating to control over the vehicle electrical power generation for battery recharging.

### DETAILED DESCRIPTION

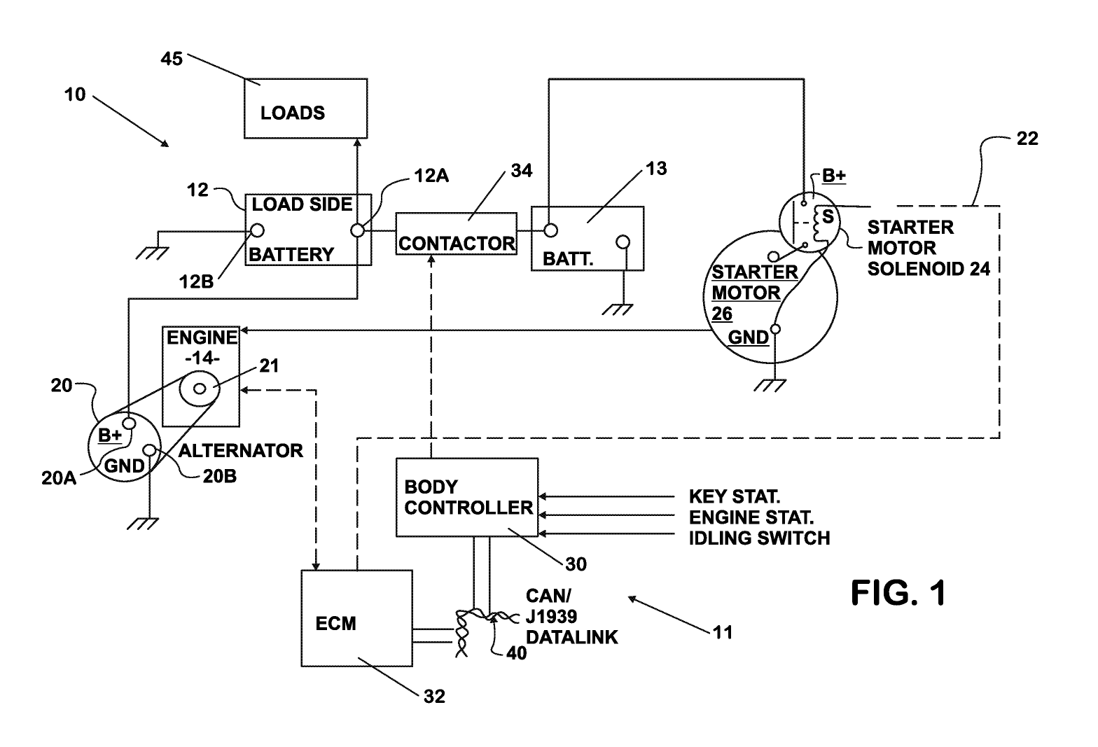

Referring to FIG. 1, a high level schematic of a vehicle electrical power system 10 is illustrated. The vehicle electrical power system 10 includes a chassis battery 12, a cranking battery 13, a generator in the form of an alternator 20 connected to supply electricity to the chassis battery 12 and to various loads 45 which represent electrical power consumers installed on a vehicle other than a starter motor, an internal combustion/thermal engine 14 connected by a mechanical couple 21 to the alternator 20 to supply mechanical power to the alternator, and a starter motor 26 for starting the internal combustion engine 14 which may be connected to the cranking battery 13 by a starter motor solenoid 24. A variety of types of batteries may be employed. For example, chassis battery 12 usually comprises one to four lead (Pb) acid automotive batteries. Cranking battery 13 may be a type of lithium ion (Li-ion) battery. Chassis battery 12 and cranking battery 13 are selectively connected and disconnected from another by a multi-state contactor 34. For example, if cranking battery 13 is composed of lithium-ion batteries recharging the batteries at low temperatures can shorten battery service life as compared to recharging at room temperatures. When multi-state contactor 34 is open the cranking battery 13 is electrically isolated from the vehicle charging system, loads 45 and chassis battery 12. The open state is the default state of multi-state contactor 34 and its open status is confirmed to prevent recharging of a lithium-ion cranking battery 13 when the battery temperature is outside of low and high limits. When multi-state contactor 34 is in a closed state electrical power may flow freely (within the capacity constraints of the circuit) from chassis battery 12 to cranking battery 13 or, under some circumstances from cranking battery 13 to chassis battery 12. This occurs to allow the cranking battery 13 to be recharged when its temperature is within the preset bounds. A third state for multi-state contactor 34 allows limited current flow between the batteries. This is used should a voltage mismatch between the chassis battery 12 and cranking battery 13 be such as a current surge would result if the free flow of power be allowed.

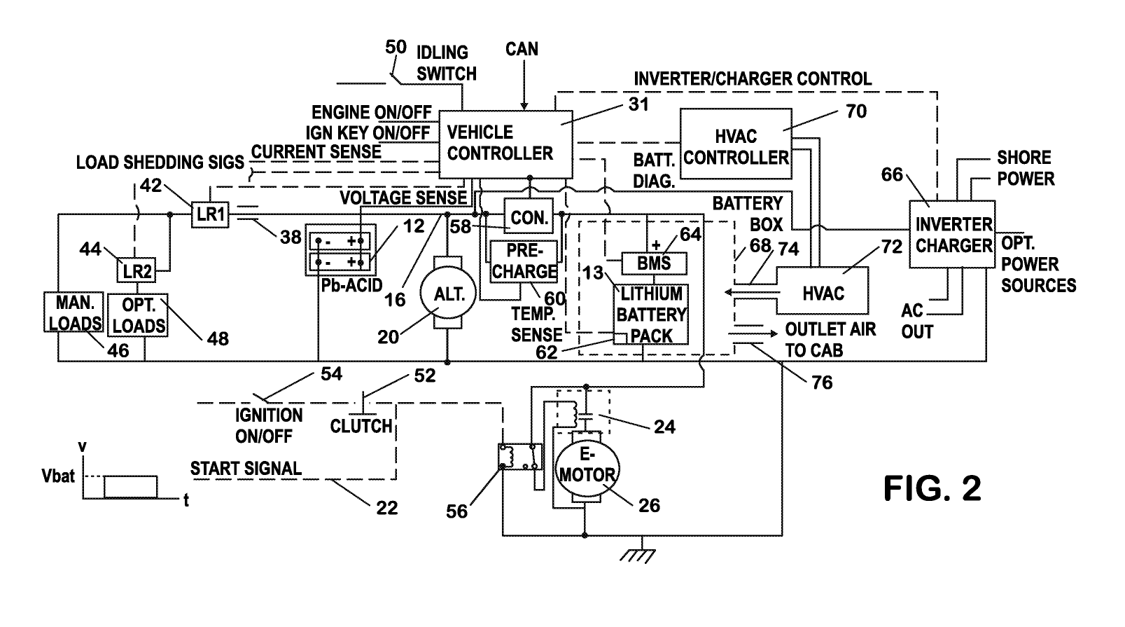

A control system 11 provides operational control (along dashed lines) of electrical power system 10. Control system 11 includes elements such as an engine control module 32, a body controller 30 and a controller area network (CAN) serial data link 40. The serial data link 40 usually conforms to the SAE J1939 standard governing its physical and software layers and provides two-way data communications between the controllers. Body controller 30 may be used for voltage sensing or more sophisticated measures may be used to determine a battery state of charge (SOC) for chassis battery 12 or cranking battery 13. Engine control module (ECM) 32 monitors whether internal combustion engine 14 is running and provides an engine status signal over serial datalink 40 which is read by body controller 30. ECM 32 can shut down internal combustion engine 14 based on instructions received from body controller 30 and crank internal combustion engine 14 by applying start signal on a start signal line 22 to the starter motor solenoid 24 at the request of the body controller 30. Body controller 30 is connected to receive the engine status signal as well as an ignition key position signal (e.g. the auxiliary position or the run position) and to monitor the position of an idling switch 50. Idling switch 50 enables duration limited idling operation of the internal combustion engine 14 to recharge the chassis battery 12 and cranking battery 13 without concurrent driver intervention. Body controller 30 develops estimates for the state of charge of chassis battery 12 or cranking battery 13 (shown in FIG. 2). The battery state of charge estimates are typically based on a proxy for state of charge such as battery terminal to terminal voltage. Body controller 30 controls the state of the multi-state contactor 34.

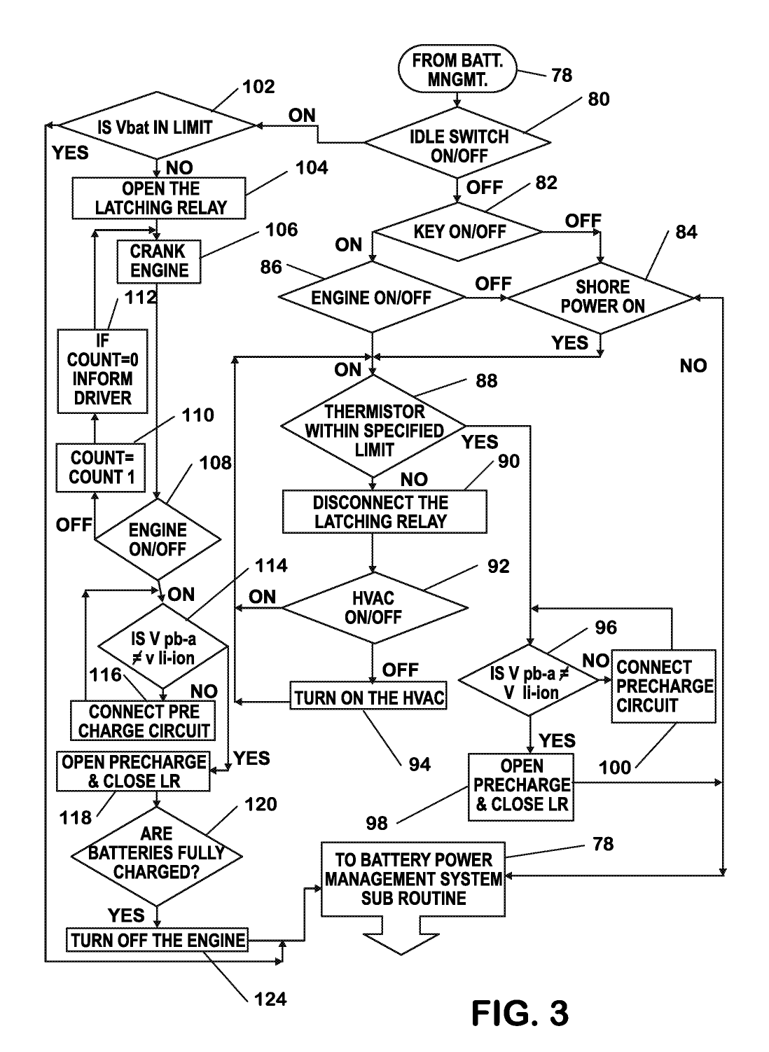

FIG. 2 illustrates a possible vehicle electrical power system 10 in greater detail. Vehicle electrical loads are divided into two groups categorized by operational priority as mandatory loads 46 and optional loads 48. Latching relays 42 and 44 are provided connected between chassis battery 12 and the mandatory and optional loads 46, 48 enabling a vehicle controller to independently shed the optional loads 48 or to jointly shed the optional and mandatory loads 48, 46 as dictated by a Battery Power Management routine 78 (see FIG. 3). Vehicle controller may be understood as a functional conflation of elements of control system 11 including engine control module 32 and body controller 30. Current drawn by the mandatory and optional loads 46, 48 is measured by a Hall effect current sensor 38 positioned relative to power bus 16. Limited duration idling operation of the internal combustion engine 14 for battery charging on a parked vehicle can occur within the broader context of a load management program monitoring operation of mandatory and optional loads 46, 48 occurring during such periods.

Power bus 16 is interruptible by a contactor 58 and a precharge circuit 60, which are positioned in the bus between a cranking battery 13, connected to one section of the power bus 16, and the chassis battery 12 and alternator 20, which are connected to another section of the power bus 16. In effect, contactor 58 in combination with precharge circuit 60 implement a multi-state contactor between chassis battery 12 and cranking battery 13 by providing states where there is no connection between the batteries, where there is current limited connection between the batteries and where there is “full” connection. Generally the precharge circuit 60 and the contactor 58 are not concurrently closed as such a state would be almost indistinguishable from simple closure of the contactor 58 alone.

Vehicle controller 31 is provided with a voltage sense line 36 to the positive terminal of the chassis battery 12 and with a connection to a battery management system (BMS) 64 which is provided with the lithium-ion battery pack and which provides data relating to cranking battery 13 to the vehicle controller. BMS 64 can provide the vehicle controller with cranking battery 13 with voltage and state of charge measurements. Typically BMS 64 also provides a battery temperature reading. If such functionality is not available a thermistor 62 in contact with cranking battery 13 and communicating with vehicle controller may be added.

Cranking battery 13 is located in a battery compartment 68 and battery compartment 68 may be placed in the vehicle crew cab. Locating the battery compartment 68 in the vehicle crew cabin provides an environment for the cranking battery 13 offering protection from extreme temperature transients, preventing exposure to road hazards and weather conditions and allowing the temperature around the cranking battery to be controlled. In order to reduce the chances for chassis battery 13 overheating cooled air, or air drawn from outside the vehicle, may be directed into the battery compartment 68 environment from the vehicle heating, ventilation and air conditioning (HVAC) system 72 may be routed through the battery compartment 68 by an inlet 74 from the HVAC system 72 and discharge outlet 76 to the crew cab. Additionally, the chassis battery 13 may be kept warm by directing heated air from the HVAC system 72 into battery compartment 68. HVAC system 72 is provided with an HVAC controller in communication with the vehicle controller. Air routed through HVAC system 72 is termed “treated air”.

Some vehicles may provide for connection of the electrical power system 10 to an external source of power. The manner of the connection depends upon the character of the external source. One type of power, conventionally referred to as “shore power” is household or industrial alternating current electrical power, for example: 100-120 volt, 60 cycle power; or 200-240 volt, 50 cycle power. An inverter charger 66 may be provided which accepts utility mains input power by a “shore power” connection and produces a direct current output of the appropriate voltage on power bus 16. The output of the inverter charger 66 is connected to the alternator side of power bus 16 relative to contactor 58. Inverter charger 66 may also pass the shore power to an onboard AC distribution system and may allow for connections to alternative sources of power. A connection is provided allowing control and data signals to be communicated between the vehicle controller 31 and the inverter charger 66.

An electric starter or cranking motor 26 draws energization from cranking battery 68 upon application of an input or starter signal from the vehicle control system (an alternative ignition path based on ignition key 54 position and clutch position sense switch 52 also exists). The starter signal is applied to a starter relay 56 which in turn engages a starter solenoid 24 in line with the cranking motor 26.

Operation of the control system 11 in relation to handling of recharging of the chassis and cranking batteries 12, 13 by the electrical power system 10 is described by reference to the flow chart of FIG. 3. During periods when a vehicle is parked, and continuous operation of the vehicle's internal combustion engine 14 discouraged notwithstanding ongoing demands for electrical power, the vehicle may be placed in an automatic (duration limited) idling mode where the engine is started and run for limited periods as required to recharge the chassis battery 12 and potentially the cranking battery 13.

The recharging routine can provide for cranking battery 13 temperature protection as well as protection from excessive current inrush. From the battery power consumption management routine (step 78) execution advances to step 80 for determination of the position of the idling switch 50. If the idling switch 50 is off temperature protection only is at issue. Advancing along the “OFF” branch from step 80 it is determined if the vehicle ignition key position is “ON” or “OFF”. IF “OFF”, it is next determined at step 84 if shore power is available. If shore power is not available along this processing progression recharging cannot occur and the routine is exited back to the battery management routine 78. The same result obtains if the ignition key 54 is detected as being ON at step 82 but the engine is “OFF” as determined at step 86 and shore power (step 84) is not available or OFF.

If the engine is determined to be ON at step 86, or if shore power is ON (determined at step 84), the process advances to step 88 for control over battery charging. The default state for contactor 58 is the open state and the default state for the precharge circuit is non-conductive. At step 88 it is determined from thermistor 62 or BMS 64 if the temperature of the cranking battery 13 is above the minimum which allows for charging and below a safe limit. If NO then step 90 confirms that the contactor 58 is open and the precharge circuit 60 is non-conductive (open). Next the status of the HVAC system 72 is checked. If ON the routine loops back to step 88. If OFF then the HVAC system 72 is turned on (step 94) to heat or cool the battery compartment 68 in order to adjust the temperature of cranking battery 13 so that it falls within the temperature limits for charging.

Once battery compartment 68 temperature is within the preselected limit, the YES branch is followed from step 88 to step 96 where the relative voltages of the chassis battery 12 (Vpb) and cranking battery 13 (Vli-ion) are compared. If the voltage difference exceeds a maximum allowed difference than the precharge circuit 60 is turned on (the contactor 58 remains open) (step 100). The process loops until the voltage difference is less than the allowed difference whereupon step 98 is executed to turn off the precharge circuit 60 and close the contactor 58. The process is exited to the battery management routine 78.

Returning to decision step 80 the process following detection of an “ON” idling switch 50 is followed. Idling switch 50 is ON only if the default state of the internal combustion engine 14 is “OFF”. Idling switch 50 is conventionally used when a vehicle is parked and electrical power demands on the chassis battery 12 are expected. At step 102 the state of charge of the batteries is checked. If the state of charge for chassis battery 12 and cranking battery 13 meet or exceed a minimum limit process execution is returned to the battery power management routine 78 along the YES branch. As described above a proxy for state of charge, such as terminal to terminal voltage indicated by Vbat may be used.

If the battery state of charge does not meet the minimum threshold, indicating a need for recharging, the NO branch is followed from decision step 102 to step 104 where it is confirmed that power is not being conducted between the chassis battery 12 and alternator 20 to cranking battery 13. The default open state of contactor 58 is confirmed at step 104. Next, at step 106 signal line 22 goes high to initiate engine cranking (step 106). Self sustained engine 14 operation is monitored for at step 108, with the monitoring process looping back to maintain engine cranking following the “OFF” branch from step 108 through steps 110 and 112. Steps 110 and 112 implement a time out procedure limiting how long engine cranking is maintained (or more precisely, how many times the engine is allowed to crank). If cranking fails an abort provision is provided (step 112) for advising the vehicle operator. Once engine 14 is running the “ON” branch if followed from step 108 to step 114 where it is determined if chassis battery 12 voltage and cranking battery 13 voltage are close enough to allow unimpeded power flow between the batteries.

From step 114 the process can follow the NO path indicating a voltage difference which is exceeds the limit for unimpeded power flow. At step 116 the precharge circuit 60 is turned on allowing limited current flow, typically from the chassis battery 12 side of the power bus 16 to the cranking battery 13 side of the power bus. This state is maintained until the voltage difference diminishes enough to allow closing the contactor 58 to permit unimpeded power flow, as provided along the YES branch from step 114 to step 118 where it is indicated that the precharge circuit 60 is turned off or “opened” and the contactor 58 is closed. Once the chassis and cranking batteries 12, 13 are fully charged (as determined at step 120) the engine 14 is turned off (step 124). A NO branch loop back on step 120 is omitted but will be understood to be inherent. Once the engine 14 is turned off the process returns to battery management 78. Hysteresis is built into the system in that the state of charge level which initiates charging is less than the state of charge required to shut down the engine 14.

What is claimed is:

1. A motor vehicle electrical power supply system, comprising:
an engine for producing mechanical power;
a generator mechanically coupled to the engine to receive mechanical power for generation of electrical power;
a chassis battery connected to receive electrical power from the generator;
a starter motor for cranking the engine;
a cranking battery for supplying electrical power to the starter motor responsive to a start signal;
a multi-state connector between the chassis battery and the cranking battery, the multi-state connector having a closed state in which electrical power can flow between the chassis battery and the cranking battery and an open state which interrupts electrical power flow from the chassis battery and generator to the cranking battery;
an idling enable switch having active and inactive states;
means for determining a battery state of charge for at least one of the cranking battery and the chassis battery; and
a controller responsive to the idling enable switch being in its active state and the determined battery state of charge for controlling periodic starting and stopping of the engine.

2. A motor vehicle electrical power supply system as set forth in claim 1, further comprising:
the multi-state connector having a limited closed state in which electrical power flow between the chassis battery and the cranking battery is surge limited.

3. A motor vehicle electrical power supply system as set forth in claim 2, the multi-state connector further comprising:
a contactor connected between the chassis battery and the cranking battery; and
a precharge circuit connected in parallel with the contactor between the chassis battery and the cranking battery, the contactor being open and the precharge circuit being active to provide surge limited electrical power flow between the chassis battery and the cranking battery responsive to a voltage difference between the chassis battery and the cranking battery.

4. A motor vehicle electrical power supply system as set forth in claim 2, further comprising:
an inverter allowing connection to a source of external electrical power; and
an output from the inverter being connected to the chassis battery.

5. A motor vehicle electrical power supply system as set forth in claim 2, further comprising:
a temperature sensing element for the cranking battery; and
means responsive to temperature measurements for the cranking battery for setting the state of the multi-state connector.

6. A motor vehicle electrical power supply system as set forth in claim 4, further comprising:
a battery compartment for the cranking battery;
a heating, ventilation and air conditioning system and an outlet to the battery compartment; and
means responsive to the temperature measurements for activating the heating, ventilation and cooling system for controlling the temperature in the battery compartment.

7. An electrical power supply system comprising:
an internal combustion engine;
an alternator mechanically coupled to the internal combustion engine to generate electricity;
an electrical starter motor mechanically coupled to the internal combustion engine for cranking the internal combustion engine for starting;
a chassis battery electrically connected to the alternator;
a cranking battery;
a contactor connected between the chassis battery and the cranking battery;
a precharge circuit connected between the chassis battery and the cranking battery allowing limited current flow between the chassis battery and the cranking circuit;
a plurality of electrical loads connected for energization from the chassis battery and alternator independent of the conductive state of the contactor or the precharge circuit; and
the electrical starter motor connected for energization from the cranking battery independent of the conductive state of the contactor or the precharge circuit.

8. An electrical power supply system as set forth in claim 7, further comprising;
a controller for setting operative states for the contactor and the precharge circuit.

9. An electrical power supply system as set forth in claim 8, further comprising:
a temperature sensor for the cranking battery connected to provide cranking battery temperature measurements to the controller; and
the controller being responsive to temperature measurements outside a predetermined limit for setting the contactor and the precharge circuit in non-conductive operative states.

10. An electrical power supply system as set forth in claim 8, further comprising:
means for generating state of charge measurements for at least one of the cranking battery and the chassis battery;
the controller being responsive to the state of charge measurements for setting conductive operative states of one of the contactor and the precharge circuit.

11. An electrical power supply system as set forth in claim 10, further comprising:
the controller being further responsive to the state of charge measurements indicating a state of discharge of one or more of the cranking battery and the chassis battery for initiating operation of the cranking motor until the internal combustion engine starts running.

12. An electrical power supply system as set forth in claim 11, further comprising:
the controller being further responsive to a potential difference between the chassis battery and the cranking battery exceeding an allowed difference occurring concurrently with the internal combustion engine running for setting the precharge circuit in a conductive operative state and the contactor in an open operative state until the potential difference falls below the allowed difference and thereafter setting the contactor in a closed operative state.

13. An electrical power supply system as set forth in claim 8, further comprising:
an inverter charger allowing connection to a source of shore power;
an output from the inverter charger connected to the chassis battery allowing the source of shore power to be isolated from the cranking battery depending upon the operative state of the precharge circuit and the contactor.

14. An electrical power supply system as set forth in claim 12, further comprising:
a plurality of loads selectively connectable to the chassis battery.

15. An electrical power supply system as set forth in claim 9, further comprising:
a heating, ventilation and air conditioning system including means for delivering treated air to an environment around the cranking battery; and
the controller being responsive to temperature measurements outside the predetermined limit for causing the heating, ventilation and air conditioning system to deliver treated air to the environment to bring temperature measurements relating to the cranking battery within the predetermined limits.
